(19) United States
(12) Patent Application Publication
(10) Pub. No.: US 2023/0294720 A1
(43) Pub. Date: Sep. 21, 2023

(54) DRIVE ASSIST APPARATUS AND DRIVE ASSIST METHOD

(71) Applicant: Mitsubishi Electric Corporation, Tokyo (JP)

(72) Inventors: Yusuke SUZUKI, Tokyo (JP); Mitsuo SHIMOTANI, Tokyo (JP)

(73) Assignee: Mitsubishi Electric Corporation, Tokyo (JP)

(21) Appl. No.: 18/015,243

(22) PCT Filed: Aug. 20, 2020
(86) PCT No.: PCT/JP2020/031441

§ 371 Date: Jan. 9, 2023

(51) Int. Cl. B60W 50/08; B60W 30/09; B60W 40/04

(52) U.S. Cl. CPC B60W 50/08; B60W 30/09; B60W 40/04

(57) ABSTRACT

An object of the present disclosure is to provide a drive assist apparatus capable of performing appropriate drive assist on a driver which has performed reckless driving or irritating driving and a drive assist method thereof. A drive assist apparatus according to the present disclosure includes: a drive state determination unit determining a drive state including reckless driving intentionally performed by a driver of a subject vehicle on another vehicle and irritating driving accidentally performed by a driver of a subject vehicle but irritating a driver of another vehicle; and an assist controller performing control of assisting driving of the driver of the subject vehicle in accordance with each of a case where the drive state determination unit determines that the reckless driving is performed and a case where the drive state determination unit determines that the irritating driving is performed.

### TECHNICAL FIELD

The present disclosure relates to a drive assist apparatus performing appropriate drive assist on a driver which has performed risky driving and a drive assist method.

### BACKGROUND ART

Conventionally disclosed is a technique of detecting risky driving such as reckless driving by a driver of a subject vehicle and notifying the driver when detecting the risky driving (refer to Patent Document 1, for example).

In Patent Document 1, obtained is inter-vehicle distance between a subject vehicle and the other vehicle traveling in front of the subject vehicle (first information) and information indicating a relative positional relationship between right and left lines defining a travel lane of the subject vehicle and the subject vehicle in a right and left direction (second information), and when it is determined that the inter-vehicle distance is small based on the first information and is abnormal (not normal) based on the second information and a statistic value, the driving is deemed to be “risky driving” and the driver is notified by an alarm, for example.

### PRIOR ART DOCUMENTS

### Patent Document(s)

Patent Document 1: Japanese Patent Application Laid-Open No. 2020-24580

### SUMMARY

### Problem to Be Solved by the Invention

It is considered that the risky driving includes reckless driving intentionally performed by a driver of a subject vehicle on the other vehicle and irritating driving accidentally performed by a driver but irritating a driver of the other vehicle. For example, when a warning tone is emitted to a driver performing the reckless driving, there is a possibility that the driver is rasped and performs risky driving more excessively. In the meanwhile, when a warning tone is emitted to a driver performing the irritating driving, there is a possibility that the driver recognizes his/her driving state and revises the driving. Accordingly, it is considered to be effective to perform drive assist on the driver of the subject vehicle in accordance with each of the reckless driving and the irritating driving.

In Patent Document 1, the driver is uniformly notified of the risky driving without distinction of the reckless driving and the irritating driving, thus there is a possibility that the above problem occurs. Accordingly, it is not considered that appropriate drive assist is performed on the driver which has performed the reckless driving or the irritating driving in Patent Document 1.

The present disclosure is to solve such a problem, and an object is to provide a drive assist apparatus capable of performing appropriate drive assist on a driver which has performed reckless driving or irritating driving and a drive assist method thereof.

### Means to Solve the Problem

In order to solve the above problem, a drive assist apparatus according to the present disclosure includes: a drive state determination unit determining a drive state including reckless driving intentionally performed by a driver of a subject vehicle on another vehicle and irritating driving accidentally performed by a driver of a subject vehicle but irritating a driver of another vehicle; and an assist controller performing control of assisting driving of the driver of the subject vehicle in accordance with each of a case where the drive state determination unit determines that the reckless driving is performed and a case where the drive state determination unit determines that the irritating driving is performed.

### Effects of the Invention

According to the present disclosure, in the drive assist apparatus, the drive state determination unit performs control of assisting driving of the driver of the subject vehicle in accordance with each of the case where the drive state determination unit determines that the reckless driving is performed and the case where the drive state determination unit determines that the irritating driving is performed, thus appropriate drive assist can be performed on the driver who has performed the reckless driving or the irritating driving.

These and other objects, features, aspects and advantages of the present disclosure will become more apparent from the following detailed description when taken in conjunction with the accompanying drawings.

### BRIEF DESCRIPTION OF DRAWINGS

FIG. 1 is a block diagram illustrating an example of a configuration of a drive assist apparatus according to an embodiment 1.

FIG. 2 is a block diagram illustrating an example of the configuration of the drive assist apparatus according to the embodiment 1.

FIG. 3 is a diagram illustrating an example of drive assist according to the embodiment 1.

FIG. 4 is a diagram illustrating an example of drive assist according to the embodiment 1.

FIG. 5 is a diagram illustrating an example of drive assist according to the embodiment 1.

FIG. 6 is a diagram illustrating an example of drive assist according to the embodiment 1.

FIG. 7 is a diagram illustrating an example of drive assist according to the embodiment 1.

FIG. 8 is a flow chart illustrating an example of an operation of the drive assist apparatus according to the embodiment 1.

FIG. 9 is a block diagram illustrating an example of a configuration of a drive assist apparatus according to a modification example of the embodiment 1.

FIG. 10 is a block diagram illustrating an example of a configuration of a drive assist apparatus according to an embodiment 2.

FIG. 11 is a diagram illustrating an example of drive assist according to the embodiment 2.

FIG. 12 is a diagram illustrating an example of drive assist according to the embodiment 2.

FIG. 13 is a diagram illustrating an example of drive assist according to the embodiment 2.

FIG. 14 is a diagram illustrating an example of drive assist according to the embodiment 2.

FIG. 15 is a diagram illustrating an example of drive assist according to the embodiment 2.

FIG. 16 is a flow chart illustrating an example of an operation of the drive assist apparatus according to the embodiment 2.

FIG. 17 is a block diagram illustrating an example of a configuration of a drive assist apparatus according to a modification example of the embodiment 2.

FIG. 18 is a block diagram illustrating an example of a configuration of a drive assist apparatus according to an embodiment 3.

FIG. 19 is a diagram illustrating an example of drive assist according to the embodiment 3.

FIG. 20 is a flow chart illustrating an example of an operation of the drive assist apparatus according to the embodiment 3.

FIG. 21 is a block diagram illustrating an example of a configuration of a drive assist apparatus according to a modification example of the embodiment 3.

FIG. 22 is a block diagram illustrating an example of a configuration of a drive assist apparatus according to an embodiment 4.

FIG. 23 is a diagram illustrating an example of drive assist according to the embodiment 4.

FIG. 24 is a flow chart illustrating an example of an operation of the drive assist apparatus according to the embodiment 4.

FIG. 25 is a block diagram illustrating an example of a configuration of a drive assist apparatus according to an embodiment 5.

FIG. 26 is a block diagram illustrating an example of a hardware configuration of the drive assist apparatus according to the embodiments 1 to 5.

FIG. 27 is a block diagram illustrating an example of a hardware configuration of the drive assist apparatus according to the embodiments 1 to 5.

FIG. 28 is a block diagram illustrating an example of a configuration of a drive assist system according to the embodiments 1 to 5.

### DESCRIPTION OF EMBODIMENT(S)

### Embodiment 1

### <1-1. Configuration>

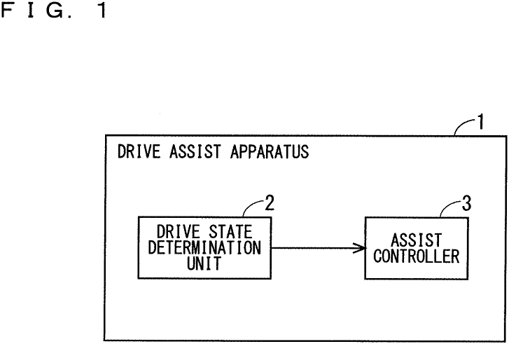

FIG. 1 is a block diagram illustrating an example of a configuration of a drive assist apparatus 1 according to an embodiment 1. FIG. 1 illustrates a bare minimum of configuration constituting a drive assist apparatus according to the embodiment 1. The drive assist apparatus 1 is mounted in a vehicle (referred to as “subject vehicle” hereinafter).

As illustrated in FIG. 1, the drive assist apparatus 1 includes a drive state determination unit 2 and an assist controller 3.

The drive state determination unit 2 determines a drive state including reckless driving intentionally performed by a driver of a subject vehicle on the other vehicle and irritating driving accidentally performed by a driver but irritating a driver of the other vehicle. The assist controller 3 performs control of assisting driving of the driver of the subject vehicle in accordance with each of a case where the drive state determination unit 2 determines that the reckless driving is performed and a case where the drive state determination unit 2 determines that the irritating driving is performed.

Described next is the other configuration including the drive assist apparatus 1 illustrated in FIG. 1.

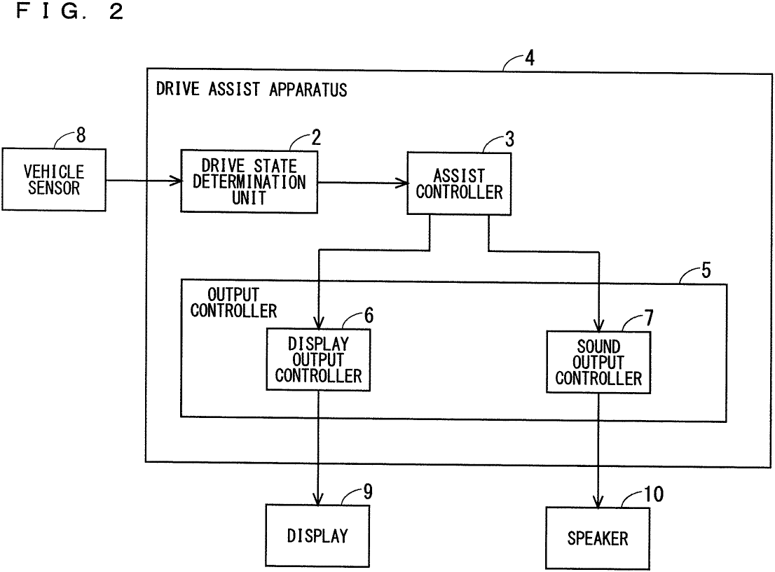

FIG. 2 is a block diagram illustrating an example of a configuration of a drive assist apparatus 4 according to the other configuration.

As illustrated in FIG. 2, the drive assist apparatus 4 includes the drive state determination unit 2, the assist controller 3, and an output controller 5. The output controller 5 includes a display output controller 6 and a sound output controller 7. The drive state determination unit 2 is connected to a vehicle sensor 8, the display output controller 6 is connected to a display 9, and the sound output controller 7 is connected to a speaker 10.

The vehicle sensor 8 detects a relative position of the other vehicle with respect to the subject vehicle and a state around the subject vehicle including traffic lanes along which the subject vehicle and the other vehicle travel. The vehicle sensor 8 may obtain a relative speed of the other vehicle based on a temporal change of the relative position of the other vehicle.

The vehicle sensor 8 may be a camera, for example. When the vehicle sensor 8 is the camera, image processing is performed on an image of an area around the subject vehicle taken by the camera, thus the relative position of the other vehicle with respect to the subject vehicle and the traffic lanes along which the subject vehicle and the other vehicle travel.

The drive state determination unit 2 determines a drive state including reckless driving and irritating driving based on information obtained from the vehicle sensor 8. Specifically, when the subject vehicle executes a particular action more than a predetermined number of times on the same other vehicle, the drive state determination unit 2 determines that a driver of the subject vehicle performs the reckless driving. When the subject vehicle temporarily executes a particular action on the same other vehicle, the drive state determination unit 2 determines that a driver of the subject vehicle performs the irritating driving.

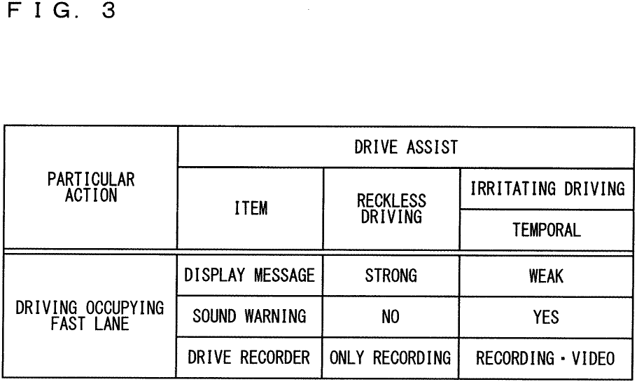

Examples of the particular actions which the drive state determination unit 2 refers to in determining the reckless driving and the irritating driving include each particular action illustrated in FIGS. 3 to 7. That is to say, examples of the particular action include “driving occupying a fast lane”, “pulling over to the other vehicle”, “cutting into a lane of the other vehicle”, “approach to a preceding vehicle”, “unsteady driving with respect to a preceding vehicle”, “sudden braking with respect to a subsequent vehicle”, and “unsteady driving with respect to a subsequent vehicle”. Each particular action illustrated in FIGS. 3 to 7 is an exemplification, thus the other driving may be a particular action. For example, also applicable as the particular action is driving in a state where the subject vehicle and the other vehicle are located on a no-passing road and the subject vehicle is located in front of the other vehicle.

Each particular action illustrated in FIGS. 3 to 7 is described hereinafter.

“Driving occupying a fast lane” illustrated in FIG. 3 indicates that the driver of the subject vehicle performs driving of interfering with a traveling of the other vehicle which intends to overtake the subject vehicle in a state where the subject vehicle and the other vehicle are located on a fast lane and the subject vehicle is located in front of the other vehicle. In this case, the drive state determination unit 2 determines whether or not both the subject vehicle and the other vehicle are located on the fast lane based on information, which is obtained from the vehicle sensor 8, of the traffic lanes along which the subject vehicle and the other vehicle travel. The drive state determination unit 2 determines whether or not the subject vehicle is located in front of the other vehicle based on information of a relative position of the other vehicle with respect to the subject vehicle obtained from the vehicle sensor 8.

Then, when the drive state determination unit 2 determines that the driver of the subject vehicle performs “driving occupying a fast lane”, the drive state determination unit 2 determines which the driver performs, the reckless driving or the irritating driving, based on a type of “driving occupying a fast lane” performed by the driver. Specifically, when the driver of the subject vehicle executes “driving occupying a fast lane” more than a predetermined number of times, the drive state determination unit 2 determines that the driver performs the reckless driving. When the driver of the subject vehicle temporarily executes “driving occupying a fast lane”, the drive state determination unit 2 determines that the driver performs the irritating driving.

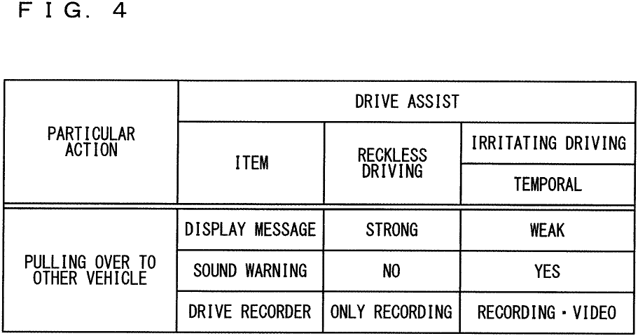

“Pulling over to the other vehicle” illustrated in FIG. 4 indicates that the driver of the subject vehicle performs driving of pulling over to the other vehicle traveling along an adjacent traffic lane. Specifically, it indicates that the driver of the subject vehicle performs driving of bringing the subject vehicle close to the other vehicle in a state where the subject vehicle and the other vehicle are located on traffic lanes adjacent to each other and travel side by side. Such a traveling of the subject vehicle is a traveling of the subject vehicle getting close to the other vehicle within a predetermined distance, and is a traveling of making the other vehicle perform an avoidance action of avoiding the subject vehicle. In this case, the drive state determination unit 2 determines whether or not the subject vehicle and the other vehicle are located on the traffic lanes adjacent to each other based on information, which is obtained from the vehicle sensor 8, of the traffic lanes along which the subject vehicle and the other vehicle travel. The drive state determination unit 2 determines whether or not the subject vehicle and the other vehicle travel side by side based on information of a relative position of the other vehicle with respect to the subject vehicle obtained from the vehicle sensor 8.

Then, when the drive state determination unit 2 determines that the driver of the subject vehicle performs “pulling over to the other vehicle”, the drive state determination unit 2 determines which the driver performs, the reckless driving or the irritating driving, based on a type of “pulling over to the other vehicle” performed by the driver. Specifically, when the driver of the subject vehicle executes “pulling over to the other vehicle” more than a predetermined number of times, the drive state determination unit 2 determines that the driver performs the reckless driving. When the driver of the subject vehicle temporarily executes “pulling over to the other vehicle”, the drive state determination unit 2 determines that the driver performs the irritating driving.

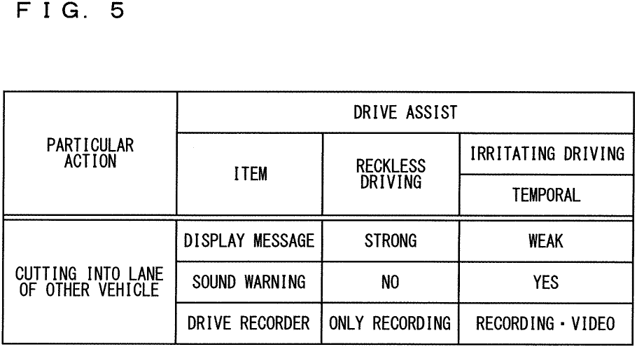

“Cutting into a lane of the other vehicle” illustrated in FIG. 5 indicates that the driver of the subject vehicle performs driving of suddenly enter in front of the other vehicle to cut into the lane of the other vehicle. Specifically, it indicates that the driver of the subject vehicle performs driving of suddenly cutting in front of the other vehicle in a state where the subject vehicle and the other vehicle travels along different traffic lanes. Such a traveling of the subject vehicle is a traveling of the subject vehicle getting close to the other vehicle within a predetermined distance, and is a traveling of making the other vehicle perform an avoidance action of avoiding the subject vehicle. In this case, the drive state determination unit 2 determines whether or not the subject vehicle and the other vehicle are located on the different traffic lanes based on information, which is obtained from the vehicle sensor 8, of the traffic lanes along which the subject vehicle and the other vehicle travel. The drive state determination unit 2 determines whether or not the subject vehicle has suddenly cut in front of the other vehicle based on information of a relative position of the other vehicle with respect to the subject vehicle obtained from the vehicle sensor 8.

Then, when the drive state determination unit 2 determines that the driver of the subject vehicle performs “cutting into a lane of the other vehicle”, the drive state determination unit 2 determines which the driver performs, the reckless driving or the irritating driving, based on a type of “cutting into a lane of the other vehicle” performed by the driver. Specifically, when the driver of the subject vehicle executes “cutting into a lane of the other vehicle” more than a predetermined number of times, the drive state determination unit 2 determines that the driver performs the reckless driving. When the driver of the subject vehicle temporarily executes “cutting into a lane of the other vehicle”, the drive state determination unit 2 determines that the driver performs the irritating driving.

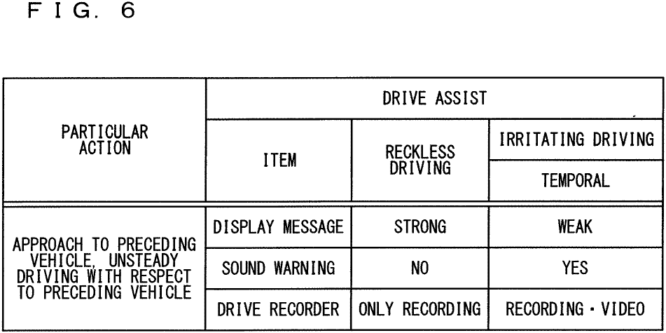

“Approach to a preceding vehicle” illustrated in FIG. 6 indicates that the driver of the subject vehicle performs driving of approaching the other vehicle in front of the subject vehicle while traveling along the same traffic lane within a predetermined distance. “Unsteady driving with respect to a preceding vehicle” indicates that the driver of the subject vehicle performs driving of unsteadily approaching the other vehicle in front of the subject vehicle while traveling along the same traffic lane within a predetermined distance. Such a traveling of the subject vehicle is a traveling of the subject vehicle getting close to the other vehicle within a predetermined distance, and is a traveling of making the other vehicle perform an avoidance action of avoiding the subject vehicle. In this case, the drive state determination unit 2 determines whether or not the subject vehicle and the other vehicle are located on the same traffic lane based on information, which is obtained from the vehicle sensor 8, of the traffic lanes along which the subject vehicle and the other vehicle travel. The drive state determination unit 2 determines whether or not the subject vehicle approaches the other preceding vehicle within a predetermined distance based on information of a relative position of the other vehicle with respect to the subject vehicle obtained from the vehicle sensor 8.

Then, when the drive state determination unit 2 determines that the driver of the subject vehicle performs “approach to a preceding vehicle” or “unsteady driving with respect to a preceding vehicle”, the drive state determination unit 2 determines which the driver performs, the reckless driving or the irritating driving, based on a type of “approach to a preceding vehicle” or “unsteady driving with respect to a preceding vehicle” performed by the driver. Specifically, when the driver of the subject vehicle executes “approach to a preceding vehicle” or “unsteady driving with respect to a preceding vehicle” more than a predetermined number of times, the drive state determination unit 2 determines that the driver performs the reckless driving. When the driver of the subject vehicle temporarily executes “approach to a preceding vehicle” or “unsteady driving with respect to a preceding vehicle”, the drive state determination unit 2 determines that the driver performs the irritating driving.

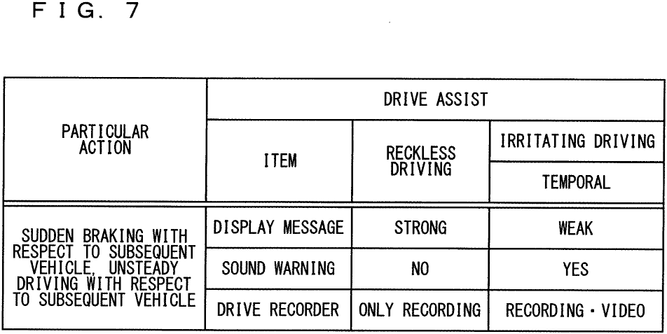

“Sudden braking with respect to a subsequent vehicle” illustrated in FIG. 7 indicates that the driver of the subject vehicle performs driving of braking suddenly in front of the other vehicle in a state where the subject vehicle and the other vehicle travel along the same traffic lane. “Unsteady driving with respect to a subsequent vehicle” indicates that the driver of the subject vehicle performs driving of unsteadily approaching the other vehicle in back of the subject vehicle within a predetermined distance in a state where the subject vehicle and the other vehicle travel along the same traffic lane. Such a traveling of the subject vehicle is a traveling of the subject vehicle getting close to the other vehicle within a predetermined distance, and is a traveling of making the other vehicle perform an avoidance action of avoiding the subject vehicle. In this case, the drive state determination unit 2 determines whether or not the subject vehicle and the other vehicle are located on the same traffic lane based on information, which is obtained from the vehicle sensor 8, of the traffic lanes along which the subject vehicle and the other vehicle travel. The drive state determination unit 2 determines whether or not the subject vehicle has suddenly braked in front of the other vehicle based on information of a relative position of the other vehicle with respect to the subject vehicle obtained from the vehicle sensor 8.

Then, when the drive state determination unit 2 determines that the driver of the subject vehicle performs “sudden braking with respect to a subsequent vehicle” or “unsteady driving with respect to a subsequent vehicle”, the drive state determination unit 2 determines which the driver performs, the reckless driving or the irritating driving, based on a type of “sudden braking with respect to a subsequent vehicle” or “unsteady driving with respect to a subsequent vehicle” performed by the driver. Specifically, when the driver of the subject vehicle executes “sudden braking with respect to a subsequent vehicle” or “unsteady driving with respect to a subsequent vehicle” more than a predetermined number of times, the drive state determination unit 2 determines that the driver performs the reckless driving. When the driver of the subject vehicle temporarily executes “sudden braking with respect to a subsequent vehicle” or “unsteady driving with respect to a subsequent vehicle”, the drive state determination unit 2 determines that the driver performs the irritating driving

Returning to the description of FIG. 2, the assist controller 3 performs control of assisting driving of the driver of the subject vehicle in accordance with each of a case where the drive state determination unit 2 determines that the reckless driving is performed and a case where the drive state determination unit 2 determines that the irritating driving is performed. Specifically, the assist controller 3 performs control of assisting driving of the driver of the subject vehicle on at least one of the display output controller 6 and the sound output controller 7.

The output controller 5 includes the display output controller 6 and the sound output controller 7. The display output controller 6 controls the display 9 so that the display 9 displays assist information of assisting driving for the driver in accordance with instruction of the assist controller 3. The sound output controller 7 controls the speaker 10 so that the speaker 10 outputs assist information with a sound to the driver in accordance with instruction of the assist controller 3.

Described hereinafter is an example of drive assist in each particular action illustrated in FIGS. 3 to 7. In FIGS. 3 to 7, “strong” in a display message indicates a message to the driver includes a warning, and “weak” in the display message indicates a message to the driver includes an attention.

As illustrated in FIG. 3, when “driving occupying a fast lane” performed by the driver of the subject vehicle is the reckless driving, the assist controller 3 transmits instruction to the display output controller 6 to display a strong display message. At this time, the assist controller 3 does not transmit the instruction to the sound output controller 7. The display output controller 6 controls the display 9 so that the display 9 displays the strong display message as the assist information for the driver. Displayed on the display 9 is a display message of “Warning: Your driving is determined as driving occupying fast lane. Please make brief stop at empty space.”, for example.

When “driving occupying a fast lane” performed by the driver of the subject vehicle is temporal irritating driving, the assist controller 3 transmits the instruction to the display output controller 6 to display a weak display message, and transmits the instruction to the sound output controller 7 to output a sound of assist information. The display output controller 6 controls the display 9 so that the display 9 displays the weak display message as the assist information for the driver. Displayed on the display 9 is a display message of “Attention: Your driving is determined as driving occupying fast lane. Please travel along driving lane as much as possible”, for example, The sound output controller 7 controls the speaker 10 so that the speaker 10 outputs a sound of assist information having the same contents as the display message. The speaker 10 outputs a sound of assist information having the same contents as the display message.

As illustrated in FIG. 4, when “pulling over to the other vehicle” performed by the driver of the subject vehicle is the reckless driving, the assist controller 3 transmits instruction to the display output controller 6 to display a strong display message. At this time, the assist controller 3 does not transmit the instruction to the sound output controller 7. The display output controller 6 controls the display 9 so that the display 9 displays the strong display message as the assist information for the driver. Displayed on the display 9 is a display message of “Warning: Your vehicle is determined to pull over to other vehicle. Please increase distance from adjacent vehicle immediately.” for example.

When “pulling over to the other vehicle” performed by the driver of the subject vehicle is temporal irritating driving, the assist controller 3 transmits the instruction to the display output controller 6 to display a weak display message, and transmits the instruction to the sound output controller 7 to output a sound of assist information. The display output controller 6 controls the display 9 so that the display 9 displays the weak display message as the assist information for the driver. Displayed on the display 9 is a display message of “Attention: Your vehicle is determined to pull over to other vehicle. Please increase distance from adjacent vehicle”, for example, The sound output controller 7 controls the speaker 10 so that the speaker 10 outputs a sound of assist information having the same contents as the display message. The speaker 10 outputs a sound of assist information having the same contents as the display message.

As illustrated in FIG. 5, when “cutting into a lane of the other vehicle” performed by the driver of the subject vehicle is the reckless driving, the assist controller 3 transmits instruction to the display output controller 6 to display a strong display message. At this time, the assist controller 3 does not transmit the instruction to the sound output controller 7. The display output controller 6 controls the display 9 so that the display 9 displays the strong display message as the assist information for the driver. Displayed on the display 9 is a display message of “Warning: Your vehicle is determined to cut into lane of other vehicle. Please stop cutting into lane suddenly.”, for example.

When “cutting into a lane of the other vehicle” performed by the driver of the subject vehicle is temporal irritating driving, the assist controller 3 transmits the instruction to the display output controller 6 to display a weak display message, and transmits the instruction to the sound output controller 7 to output a sound of assist information. The display output controller 6 controls the display 9 so that the display 9 displays the weak display message as the assist information for the driver. Displayed on the display 9 is a display message of “Attention: Your vehicle is determined to cut into lane of other vehicle. Please avoid cutting into lane suddenly.”, for example. The sound output controller 7 controls the speaker 10 so that the speaker 10 outputs a sound of assist information having the same contents as the display message. The speaker 10 outputs a sound of assist information having the same contents as the display message.

As illustrated in FIG. 6, when “approach to a preceding vehicle” or “unsteady driving with respect to a preceding vehicle” performed by the driver of the subject vehicle is the reckless driving, the assist controller 3 transmits instruction to the display output controller 6 to display a strong display message. At this time, the assist controller 3 does not transmit the instruction to the sound output controller 7. The display output controller 6 controls the display 9 so that the display 9 displays the strong display message as the assist information for the driver. Displayed on the display 9 is a display message of “Warning: Your vehicle is determined to approach to preceding vehicle. Please increase distance from preceding vehicle.”, for example.

When “approach to a preceding vehicle” or “unsteady driving with respect to a preceding vehicle” performed by the driver of the subject vehicle is temporal irritating driving, the assist controller 3 transmits the instruction to the display output controller 6 to display a weak display message, and transmits the instruction to the sound output controller 7 to output a sound of assist information. The display output controller 6 controls the display 9 so that the display 9 displays the weak display message as the assist information for the driver. Displayed on the display 9 is a display message of “Attention: Your vehicle is determined to approach to preceding vehicle. Please increase distance from preceding vehicle.”, for example. The sound output controller 7 controls the speaker 10 so that the speaker 10 outputs a sound of assist information having the same contents as the display message. The speaker 10 outputs a sound of assist information having the same contents as the display message.

As illustrated in FIG. 7, when “sudden braking with respect to a subsequent vehicle” or “unsteady driving with respect to a subsequent vehicle” performed by the driver of the subject vehicle is the reckless driving, the assist controller 3 transmits instruction to the display output controller 6 to display a strong display message. At this time, the assist controller 3 does not transmit the instruction to the sound output controller 7. The display output controller 6 controls the display 9 so that the display 9 displays the strong display message as the assist information for the driver. Displayed on the display 9 is a display message of “Warning: Your vehicle is determined to approach to subsequent vehicle. Please increase distance from subsequent vehicle.”, for example.

When “sudden braking with respect to a subsequent vehicle” or “unsteady driving with respect to a subsequent vehicle” performed by the driver of the subject vehicle is temporal irritating driving, the assist controller 3 transmits the instruction to the display output controller 6 to display a weak display message, and transmits the instruction to the sound output controller 7 to output a sound of assist information. The display output controller 6 controls the display 9 so that the display 9 displays the weak display message as the assist information for the driver. Displayed on the display 9 is a display message of “Attention: Your vehicle is determined to approach to subsequent vehicle. Please increase distance from subsequent vehicle.”, for example. The sound output controller 7 controls the speaker 10 so that the speaker 10 outputs a sound of assist information having the same contents as the display message. The speaker 10 outputs a sound of assist information having the same contents as the display message.

### <1-2. Operation>

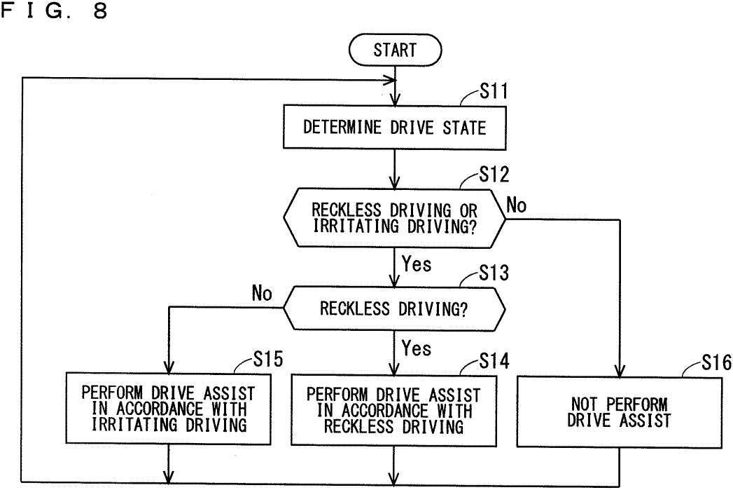

FIG. 8 is a flow chart illustrating an example of an operation of the drive assist apparatus 4.

In Step S11, the drive state determination unit 2 determines a drive state including reckless driving and irritating driving based on information obtained from the vehicle sensor 8.

In Step S12, the drive state determination unit 2 determines whether or not the drive state is reckless driving or irritating driving. When the drive state is the reckless driving or the irritating driving, the process proceeds to Step S13. In the meanwhile, when the drive state is not the reckless driving or the irritating driving, the process proceeds to Step S16.

In Step S13, the drive state determination unit 2 determines whether or not the drive state is the reckless driving. When the drive state is the reckless driving, the process proceeds to Step S14. In the meanwhile, when the drive state is not the reckless driving, the process proceeds to Step S15.

In Step S14, the assist controller 3 performs drive assist in accordance with the reckless driving. For example, when the drive state determination unit 2 determines that particular actions illustrated in FIGS. 3 to 7 are the reckless driving, the assist controller 3 transmits the instruction to the display output controller 6 to display a strong display message, and does not transmit the instruction to the sound output controller 7. The display output controller 6 controls the display 9 so that the display 9 displays a strong display message. Accordingly, the strong display message is displayed on the display 9.

In Step S15, the assist controller 3 performs drive assist in accordance with the irritating driving. For example, when the drive state determination unit 2 determines that the particular actions illustrated in FIGS. 3 to 7 are the irritating driving, the assist controller 3 transmits the instruction to the display output controller 6 to display a weak display message, and transmits the instruction to the sound output controller 7 to output a sound of assist information. The display output controller 6 controls the display 9 so that the display 9 displays a weak display message. The sound output controller 7 controls the speaker 10 so that the speaker 10 outputs a sound of assist information having the same contents as the display message. Accordingly, the display 9 displays the weak display message, and the speaker 10 outputs the sound of assist information having the same contents as the display message.

In Step S16, the assist controller 3 does not perform drive assist. That is to say, the assist controller 3 does not transmit the instruction to the display output controller 6 and the sound output controller 7.

### 1-3. Modification Example

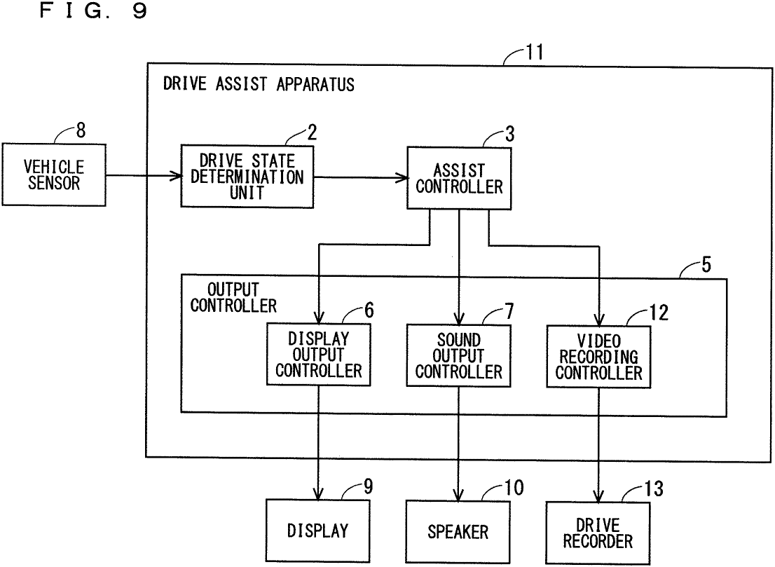

FIG. 9 is a block diagram illustrating an example of a configuration of a drive assist apparatus 11 according to a modification example. As illustrated in FIG. 9, the drive assist apparatus 11 has a feature that the output controller 5 includes a video recording controller 12. The video recording controller 12 is connected to a drive recorder 13. The other configuration and operation are similar to those of the drive assist apparatus 4 illustrated in FIG. 2, thus the detailed description is omitted herein.

The video recording controller 12 controls the drive recorder 13 so that the drive recorder 13 records a video of a drive state where the drive state determination unit 2 determines that the driving is the reckless driving or the irritating driving in accordance with the instruction of the assist controller 3. The video recording controller 12 may perform control so that the drive recorder 1 3 records a video of a drive state in an external server (not shown) where the drive state determination unit 2 determines that the driving is the reckless driving or the irritating driving.

The drive recorder 13 records the video of the drive state of the subject vehicle in accordance with the instruction of the video recording controller 12. A camera included in the vehicle sensor 8 may take the video of the drive state of the subject vehicle, or a camera (not shown) included in the drive recorder 13 may take the video thereof.

For example, when the drive state determination unit 2 determines that the particular actions illustrated in FIGS. 3 to 7 are the reckless driving, the assist controller 3 transmits the instruction to the display output controller 6 as described above, and transmits the instruction to the video recording controller 12 to record the video of the drive state where the subject vehicle performs the reckless driving. The video recording controller 12 controls the drive recorder 13 so that the drive recorder 13 records the video of the drive state where the subject vehicle performs the reckless driving. Accordingly, the video of the drive state where the subject vehicle performs the reckless driving is recorded in the drive recorder 13. Such a process is performed in Step S14 in FIG. 8. In FIGS. 3 to 7, “only record” indicates that a process of only recording the video in the drive recorder 13 is performed.

For example, when the drive state determination unit 2 determines that the particular actions illustrated in FIGS. 3 to 7 are the irritating driving, the assist controller 3 transmits the instruction to the display output controller 6 and the sound output controller 7 as described above, and transmits the instruction to the video recording controller 12 to record the video of the drive state where the subject vehicle performs the irritating driving. Accordingly, the video of the drive state where the subject vehicle performs the irritating driving is recorded in the drive recorder 13. Such a process is performed in Step S15 in FIG. 8.

In FIGS. 3 to 7, “record·video” of the drive recorder indicates that not only the process of recording the video in the drive recorder 13 is performed, but also the driver is asked whether to confirm the video recorded in the drive recorder 13 or not when the subject vehicle is stopped. In this case, also applicable is display of “Recorded is video of drive state where driving is determined to be irritating driving. Confirm recorded video? Yes/No”, for example. For example, when the video is confirmed when the subject vehicle is stopped, the driver can confirm the video by operating the drive recorder in the subject vehicle. When the video is confirmed after getting off the subject vehicle, the driver can confirm the video recorded in the drive recorder using a tablet apparatus such as a smartphone. In this case, the video stored in a cloud server may be transmitted to the tablet apparatus, or the video may be transmitted from the drive recorder to the tablet apparatus.

### 1-4. Effect

As described above, according to the embodiment 1, the drive state determination unit 2 determines whether or not the subject vehicle performs the reckless driving or the irritating driving, and the assist controller 3 controls the output controller 5 so that the output controller 5 performs drive assist in accordance with the reckless driving or the irritating driving. Accordingly, appropriate drive assist can be performed on the driver which has performed the reckless driving or the irritating driving.

### Embodiment 2

### 2-1. Configuration

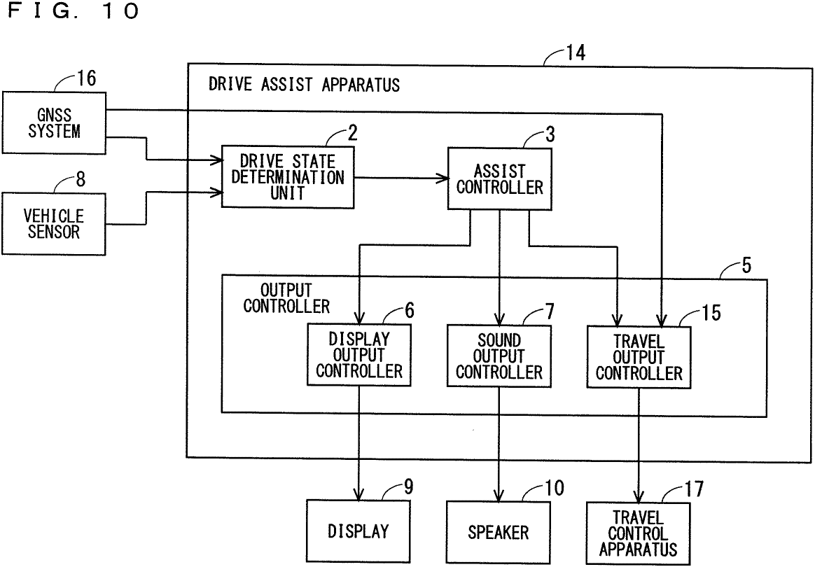

FIG. 10 is a block diagram illustrating an example of a configuration of a drive assist apparatus 14 according to an embodiment 2. As illustrated in FIG. 10, the drive assist apparatus 14 has a feature that the output controller 5 includes a travel output controller 15. The travel output controller 15 is connected to a global navigation satellite system (GNSS) system 16 and a travel control apparatus 17. The drive state determination unit 2 determines whether the irritating driving is temporal or continuous when determining that driving of the driver of the subject vehicle is the irritating driving. The other configuration and operation are similar to those of the drive assist apparatus 4 illustrated in FIG. 2, thus the detailed description is omitted herein.

The GNSS system 16 obtains map information from map database (not shown) to obtain positional information of a current position of the subject vehicle, for example.

The travel output controller 15 controls the travel control apparatus 17 so that the travel control apparatus 17 automatically controls the traveling of the subject vehicle using the information obtained from the GNSS system 16 in accordance with the instruction of the assist controller 3. Specifically, the travel output controller 15 controls the travel control apparatus 17 so that the travel control apparatus 17 automatically controls the traveling of the subject vehicle based on map information obtained from the GNSS system 16 and positional information of a current position of the subject vehicle. The travel control apparatus 17 automatically controls the traveling of the subject vehicle in accordance with the instruction of the travel output controller 15.

The drive state determination unit 2 determines a drive state including reckless driving and irritating driving based on the information obtained from the vehicle sensor 8. The drive state determination unit 2 determines whether the irritating driving is temporal or continuous when determining that driving of the driver of the subject vehicle is the irritating driving. The drive state determination unit 2 may determine a drive state in further consideration of the map information obtained from the GNSS system 16 and the positional information of the current position of the subject vehicle.

The assist controller 3 controls the display output controller 6, the sound output controller 7, and the travel output controller 15 so that they perform drive assist in accordance with each of the reckless driving, the temporal irritating driving, and the continuous irritating driving.

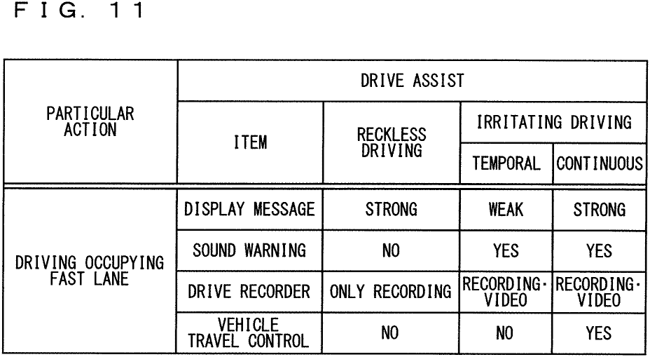

Described hereinafter is an example of drive assist in each particular action illustrated in FIGS. 11 to 15. The configuration in FIGS. 11 to 15 is similar to that in FIGS. 3 to 7 except for “vehicle travel control” in items of drive assist and “continuous” irritating driving, thus the description is omitted herein.

The assist controller 3 transmits the instruction to the travel output controller 15 so that the travel output controller 15 automatically controls the traveling of the subject vehicle only in a case where the drive state determination unit 2 determines that the driving of the driver of the subject vehicle is the continuous irritating driving. The travel output controller 15 controls the travel control apparatus 17 so that the travel control apparatus 17 automatically controls the traveling of the subject vehicle using the information obtained from the GNSS system 16.

In the example in FIG. 11, the travel control apparatus 17 automatically controls the traveling of the subject vehicle so that the subject vehicle travels at a legal speed or less. At this time, an empty space in a travel destination of the subject vehicle may be indicated on a map in the display 9. Alternatively, the travel control apparatus 17 may perform control so that the subject vehicle is automatically moved to an empty space located in a travel destination or the subject vehicle automatically changes a traffic lane.

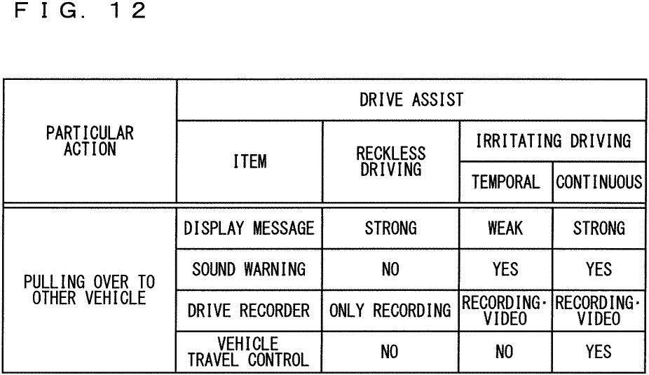

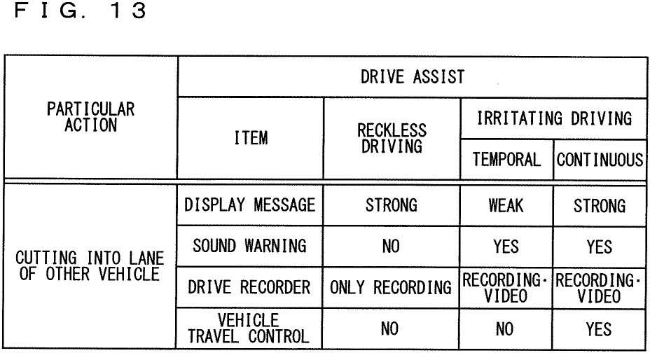

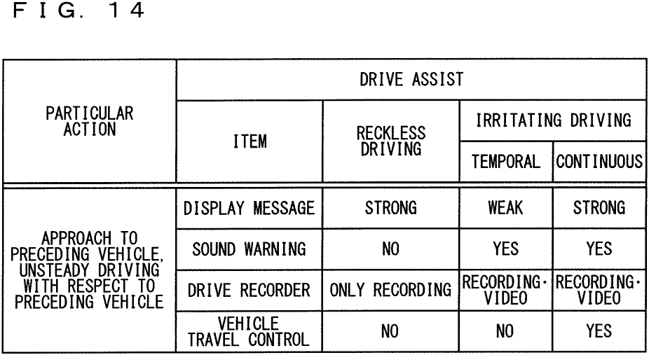

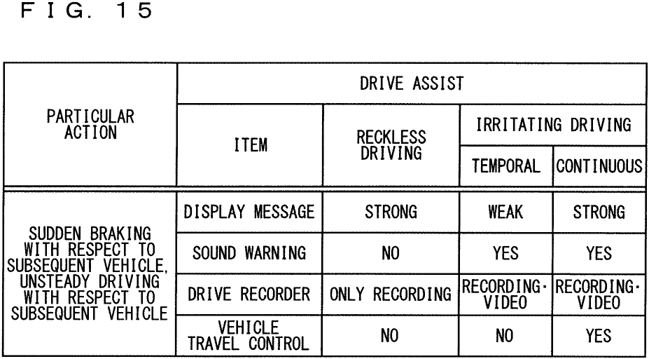

In the example in FIG. 12, the travel control apparatus 17 performs control so that the subject vehicle keeps a constant distance from an adjacent other vehicle. In the example in FIG. 13, the travel control apparatus 17 performs control so that the subject vehicle reduces the speed and is moved to an adjacent traffic lane. In the example in FIG. 14, the travel control apparatus 17 performs control so that the subject vehicle keeps a constant distance from a preceding vehicle. In the example in FIG. 15, the travel control apparatus 17 performs control so that the subject vehicle keeps a constant distance from a subsequent vehicle.

The assist controller 3 controls the display output controller 6 so that the display output controller 6 outputs different display messages in accordance with each of the temporal irritating driving and the continuous irritating driving. The display output controller 6 controls the display 9 so that the display 9 displays a weak display message in a case of the temporal irritating driving and displays a strong display message in a case of the continuous irritating driving. Contents of each of the weak display message and the strong display message in FIGS. 11 to 15 are similar to those in FIGS. 3 to 7.

### 2-2. Operation

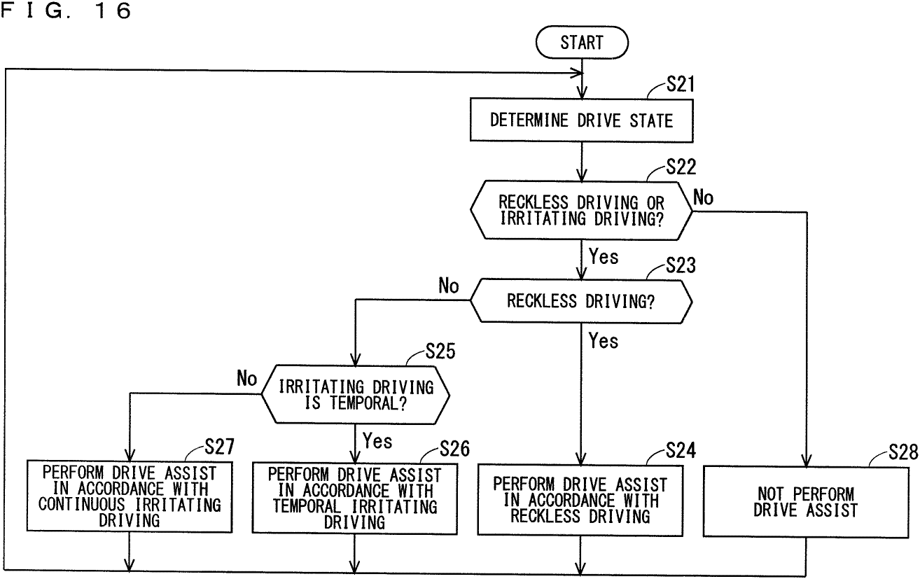

FIG. 16 is a flow chart illustrating an example of an operation of the drive assist apparatus 14. Step S21 to Step S24 in FIG. 16 correspond to Step S11 to Step S14 in FIG. 8, and Step S28 in FIG. 16 corresponds to Step S16 in FIG. 8, thus the description is omitted herein. Step S25 and Step S27 are described hereinafter.

In Step S25, the drive state determination unit 2 determines whether or not the irritating driving is temporal. When the irritating driving is temporal, the process proceeds to Step S26. In the meanwhile, when the irritating driving is not temporal, that is to say, when the irritating driving is continuous, the process proceeds to Step S27.

In Step S26, the assist controller 3 performs drive assist in accordance with the temporal irritating driving. For example, when the drive state determination unit 2 determines that the particular actions illustrated in FIGS. 11 to 15 are the temporal irritating driving, the assist controller 3 transmits the instruction to the display output controller 6 to display a weak display message, and transmits the instruction to the sound output controller 7 to output a sound of assist information. At this time, the assist controller 3 does not transmit the instruction to the travel output controller 15. The display output controller 6 controls the display 9 so that the display 9 displays a weak display message. The sound output controller 7 controls the speaker 10 so that the speaker 10 outputs a sound of assist information having the same contents as the display message. Accordingly, the display 9 displays the weak display message, and the speaker 10 outputs the sound of assist information having the same contents as the display message.

In Step S27, the assist controller 3 performs drive assist in accordance with the continuous irritating driving. For example, when the drive state determination unit 2 determines that the particular actions illustrated in FIGS. 11 to 15 are the continuous irritating driving, the assist controller 3 transmits the instruction to the display output controller 6 to display a strong display message, transmits the instruction to the sound output controller 7 to output a sound of assist information, and transmits the instruction to the travel output controller 15 to automatically control the traveling of the subject vehicle. The display output controller 6 controls the display 9 so that the display 9 displays a strong display message. The sound output controller 7 controls the speaker 10 so that the speaker 10 outputs a sound of assist information having the same contents as the display message. Furthermore, the travel output controller 15 controls the travel control apparatus 17 so that the travel control apparatus 17 automatically controls the traveling of the subject vehicle. Accordingly, the display 9 displays the weak display message, and the speaker 10 outputs the sound of assist information having the same contents as the display message. The travel control apparatus 17 automatically controls the traveling of the subject vehicle.

### 2-3. Modification Example

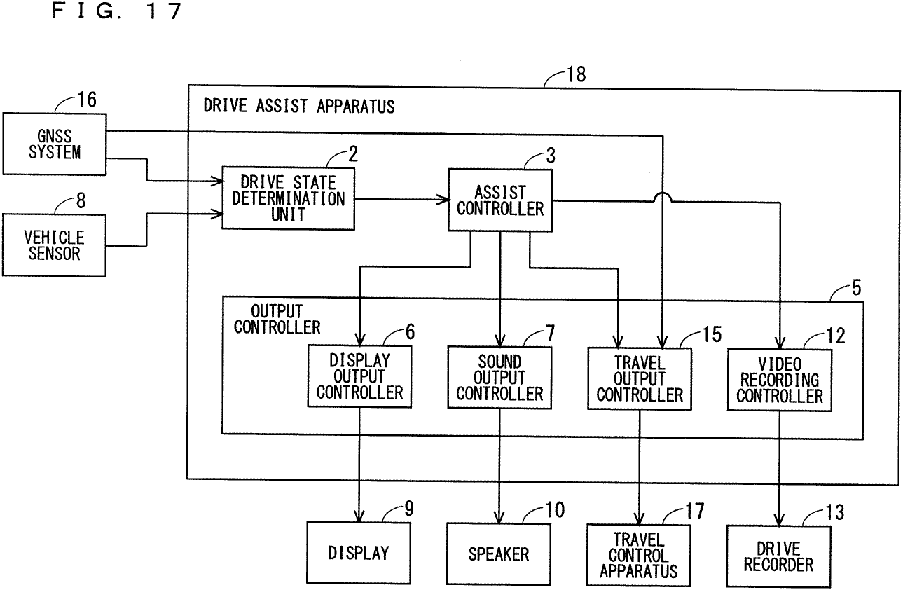

FIG. 17 is a block diagram illustrating an example of a configuration of a drive assist apparatus 18 according to a modification example. As illustrated in FIG. 17, the drive assist apparatus 18 has a feature that the output controller 5 includes the video recording controller 12. The other configuration and operation are similar to those of the drive assist apparatus 14 illustrated in FIG. 10, thus the detailed description is omitted herein.

The video recording controller 12 controls the drive recorder 13 so that the drive recorder 13 records a video of a drive state where the drive state determination unit 2 determines that the driving is the reckless driving or the irritating driving in accordance with the instruction of the assist controller 3.

The drive recorder 13 records the video of the drive state of the subject vehicle in accordance with the instruction of the video recording controller 12.

For example, when the drive state determination unit 2 determines that the particular actions illustrated in FIGS. 11 to 15 are the reckless driving, the assist controller 3 transmits the instruction to the display output controller 6 as described above, and transmits the instruction to the video recording controller 12 to record the video of the drive state where the subject vehicle performs the reckless driving. The process is similar to that in the video recording controller 12 in FIG. 9.

For example, when the drive state determination unit 2 determines that the particular actions illustrated in FIGS. 11 to 15 are the temporal or continuous irritating driving, the assist controller 3 transmits the instruction to the display output controller 6 and the sound output controller 7 as described above, and transmits the instruction to the video recording controller 12 to record the video of the drive state where the subject vehicle performs the temporal or continuous irritating driving. The process is similar to that in the video recording controller 12 in FIG. 9.

### 2-4. Effect

As described above, according to the embodiment 2, the drive state determination unit 2 determines whether or not the subject vehicle performs the reckless driving or the irritating driving, and when the subject vehicle performs the irritating driving, the drive state determination unit 2 determines whether the irritating driving is temporal or continuous. The assist controller 3 controls the output controller 5 so that the output controller 5 performs drive assist in accordance with each of the reckless driving, the temporal irritating driving, or the continuous irritating driving. Accordingly, appropriate drive assist can be performed on the driver which has performed the reckless driving, the temporal irritating driving, or the continuous irritating driving.

### Embodiment 3

### 3-1. Configuration

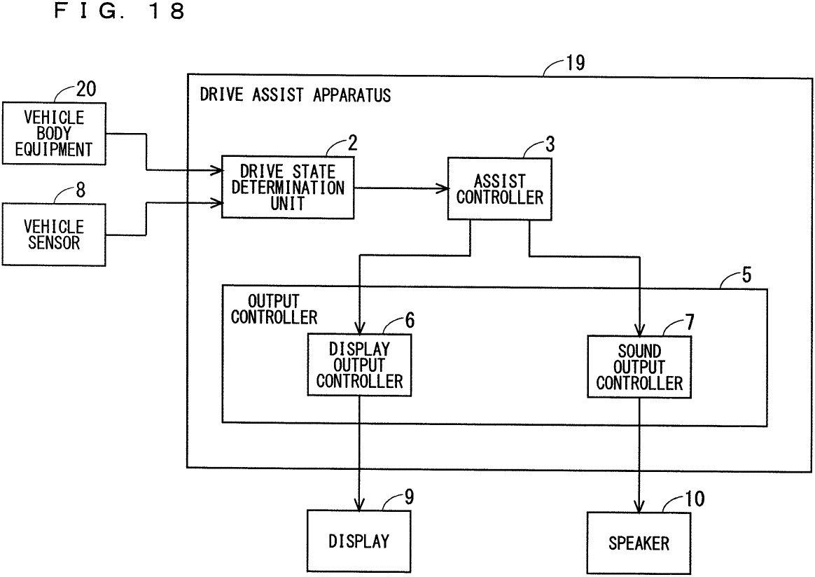

FIG. 18 is a block diagram illustrating an example of a configuration of a drive assist apparatus 19 according to an embodiment 3. The drive assist apparatus 19 has a feature in determination of a drive state performed by the drive state determination unit 2. The other configuration and basic operation are similar to those in the embodiment 1 or the embodiment 2, thus the detailed description is omitted herein.

The drive state determination unit 2 is connected to the vehicle sensor 8 and a vehicle body equipment 20. The vehicle sensor 8 is similar to the vehicle sensor 8 described in the embodiments 1 and 2. The vehicle body equipment 20 includes a horn generating a warning tone and a headlight emitting light toward a front side, for example.

The drive state determination unit 2 determines a drive state including reckless driving and irritating driving based on the information obtained from the vehicle sensor 8 and the vehicle body equipment 20. The drive state determination unit 2 determines whether the irritating driving is temporal or continuous when determining that driving of the driver of the subject vehicle is the irritating driving.

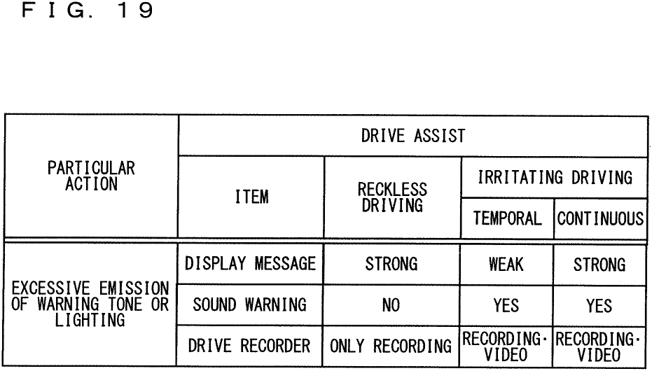

Example of the particular actions which the drive state determination unit 2 refers to in determining the reckless driving and the irritating driving based on the information obtained from the vehicle body equipment 20 include “excessive emission of warning tone or lighting” illustrated in FIG. 19. Each particular action illustrated in FIG. 19 is an exemplification, thus the other driving may be a particular action.

“Excessive emission of warning tone or lighting” in FIG. 19 indicates that the driver of the subject vehicle heavily emits the warning tone for the other vehicle in front of the subject vehicle or heavily uses flashing of lighting such as a flash with light to the other vehicle in front of the subject vehicle, for example. In this case, the drive state determination unit 2 determines whether or not the subject vehicle and the other vehicle are located on the same traffic lane based on information, which is obtained from the vehicle sensor 8, of the traffic lanes along which the subject vehicle and the other vehicle travel. The drive state determination unit 2 determines whether or not the warning tone or flashing of lighting is heavily used based on a usage state of the warning tone or the lightning obtained from the vehicle body equipment 20. Then, when the drive state determination unit 2 determines that the driver of the subject vehicle performs “excessive emission of warning tone or lighting”, the drive state determination unit 2 determines which the driver performs, the reckless driving or the irritating driving, based on a type of “excessive emission of warning tone or lighting” performed by the driver.

Specifically, when the driver of the subject vehicle executes “excessive emission of warning tone or lighting” more than a predetermined number of times, the drive state determination unit 2 determines that the driver performs the reckless driving. For example, the drive state determination unit 2 determines that the driver of the subject vehicle performs the reckless driving when the subject vehicle repeatedly emits the warning tone four times or more to the same other vehicle. The drive state determination unit 2 determines that the driver of the subject vehicle performs the reckless driving when the subject vehicle repeatedly emits the warning tone for four seconds or more and more than a predetermined number of times.

When the driver of the subject vehicle temporarily or continuously executes “excessive emission of warning tone or lighting”, the drive state determination unit 2 determines that the driver performs the temporal or continuous irritating driving. For example, when the subject vehicle emits the warning tone for one to two seconds, the drive state determination unit 2 determines that the driver performs the temporal irritating driving. For example, when the subject vehicle emits the warning tone for two to four seconds, the drive state determination unit 2 determines that the driver performs the continuous irritating driving. Furthermore, when the subject vehicle emits the warning tone twice or three times, the drive state determination unit 2 determines that the driver performs the continuous irritating driving.

The assist controller 3 controls the display output controller 6 and the sound output controller 7 so that they perform drive assist in accordance with each of the reckless driving, the temporal irritating driving, and the continuous irritating driving.

For example, as illustrated in FIG. 19, when “excessive emission of warning tone or lighting” performed by the driver of the subject vehicle is the reckless driving, the assist controller 3 transmits instruction to the display output controller 6 to display a strong display message. At this time, the assist controller 3 does not transmit the instruction to the sound output controller 7. The display output controller 6 controls the display 9 so that the display 9 displays the strong display message as the assist information for the driver. Displayed on the display 9 is a display message of “Warning: Horn is determined to be honked several times. Please stop excessive honking.”, for example,

When “excessive emission of warning tone or lighting” performed by the driver of the subject vehicle is temporal irritating driving, the assist controller 3 transmits the instruction to the display output controller 6 to display a weak display message, and transmits the instruction to the sound output controller 7 to output a sound of assist information. The display output controller 6 controls the display 9 so that the display 9 displays the weak display message as the assist information for the driver. Displayed on the display 9 is a display message of “Attention: Horn is determined to be honked several times. Please try to use warning tone appropriately.”, for example. The sound output controller 7 controls the speaker 10 so that the speaker 10 outputs a sound of assist information having the same contents as the display message. The speaker 10 outputs a sound of assist information having the same contents as the display message.

When “excessive emission of warning tone or lighting” performed by the driver of the subject vehicle is continuous irritating driving, a strong display message is displayed on the display 9, and a sound of assist information having the same contents as the display message is outputted from the speaker 10 in the manner similar to the case of the reckless driving.

### 3-2. Operation

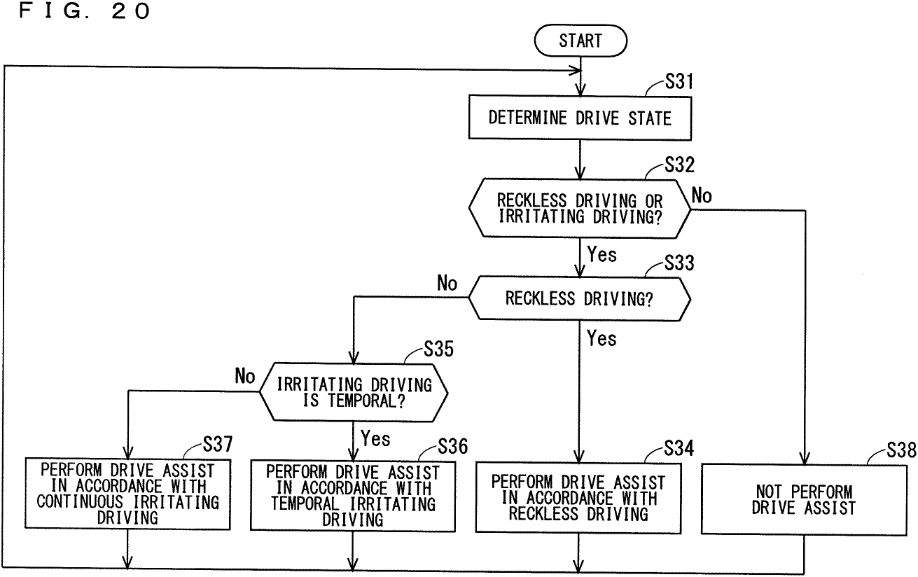

FIG. 20 is a flow chart illustrating an example of an operation of the drive assist apparatus 19. Step S33 to Step S38 in FIG. 20 correspond to Step S23 to Step S28 in FIG. 16, thus the description is omitted herein. Step S31 and Step S32 are described hereinafter.

In Step S31, the drive state determination unit 2 determines a drive state including reckless driving and irritating driving based on the information obtained from the vehicle sensor 8 and the vehicle body equipment 20.

In Step S32, the drive state determination unit 2 determines whether or not the drive state is reckless driving or irritating driving. When the drive state is the reckless driving or the irritating driving, the process proceeds to Step S33. In the meanwhile, when the drive state is not the reckless driving or the irritating driving, the process proceeds to Step S38.

### 3-3. Modification Example

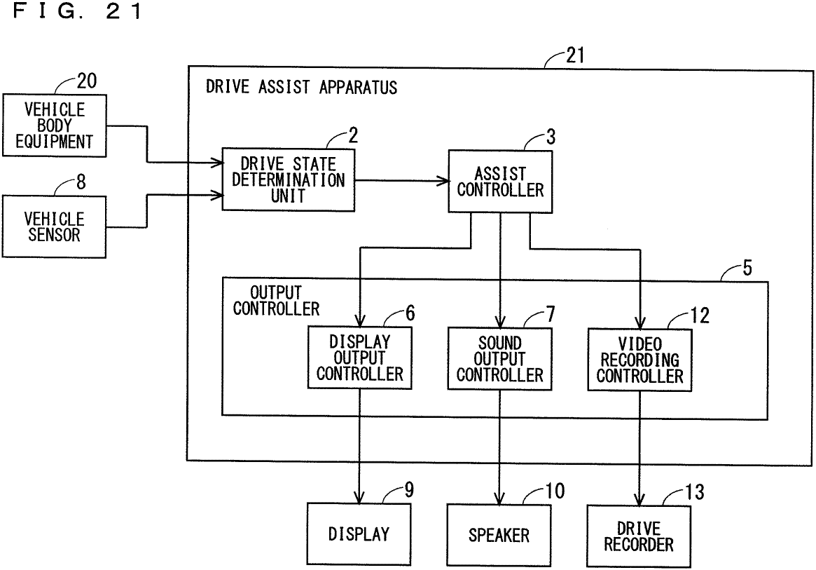

FIG. 21 is a block diagram illustrating an example of a configuration of a drive assist apparatus 21 according to a modification example. As illustrated in FIG. 21, the drive assist apparatus 21 has a feature that the output controller 5 includes the video recording controller 12. The other configuration and operation are similar to those of the drive assist apparatus 14 illustrated in FIG. 10, thus the detailed description is omitted herein.

The video recording controller 12 controls the drive recorder 13 so that the drive recorder 13 records a video of a drive state where the drive state determination unit 2 determines that the driving is the reckless driving or the irritating driving in accordance with the instruction of the assist controller 3. The drive recorder 13 records the video of the drive state of the subject vehicle in accordance with the instruction of the video recording controller 12.

For example, when the drive state determination unit 2 determines that the particular action illustrated in FIG. 19 is the reckless driving, the assist controller 3 transmits the instruction to the display output controller 6 as described above, and transmits the instruction to the video recording controller 12 to record the video of the drive state where the subject vehicle performs the reckless driving. The process is similar to that in the video recording controller 12 in FIG. 9.

For example, when the drive state determination unit 2 determines that the particular action illustrated in FIG. 19 is the temporal or continuous irritating driving, the assist controller 3 transmits the instruction to the display output controller 6 and the sound output controller 7 as described above, and transmits the instruction to the video recording controller 12 to record the video of the drive state where the subject vehicle performs the temporal or continuous irritating driving. The process is similar to that in the video recording controller 12 in FIG. 9.

### 3-4. Effect

As described above, according to the embodiment 3, the drive state determination unit 2 determines whether or not the subject vehicle performs the reckless driving or the irritating driving based on the information obtained from the vehicle body equipment 20, and when the subject vehicle performs the irritating driving, the drive state determination unit 2 determines whether the irritating driving is temporal or continuous. The assist controller 3 controls the output controller 5 so that the output controller 5 performs drive assist in accordance with each of the reckless driving, the temporal irritating driving, or the continuous irritating driving. Accordingly, appropriate drive assist can be performed on the driver which has performed the reckless driving, the temporal irritating driving, or the continuous irritating driving.

### Embodiment 4

### 4-1. Configuration

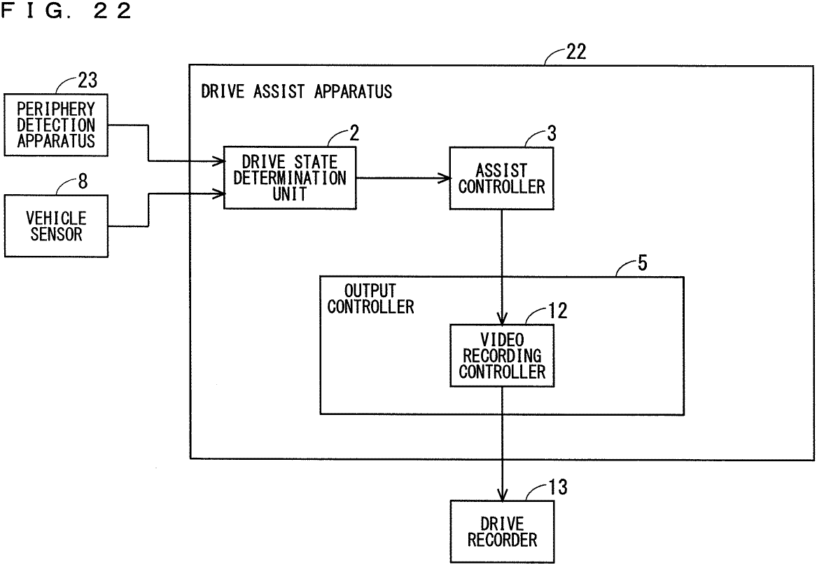

FIG. 22 is a block diagram illustrating an example of a configuration of a drive assist apparatus 22 according to an embodiment 4. The drive assist apparatus 22 has a feature that the output controller 5 includes only the video recording controller 12 and also has a feature in determination of a drive state performed by the drive state determination unit 2.

The drive state determination unit 2 is connected to the vehicle sensor 8 and a periphery detection apparatus 23. The vehicle sensor 8 is similar to the vehicle sensor 8 described in the embodiments 1 to 3. The periphery detection apparatus 23 includes a microphone collecting the warning tone emitted from the other vehicle to the subject vehicle and an illumination sensor detecting emission of light such as a flash with light from the other vehicle to the subject vehicle, for example, That is to say, the periphery detection apparatus 23 detects an action of the other vehicle on the subject vehicle.

The drive state determination unit 2 determines a drive state including reckless driving and irritating driving based on the information obtained from the vehicle sensor 8 and the periphery detection apparatus 23. Specifically, the drive state determination unit 2 determines whether or not the other vehicle is located around the subject vehicle based on the information obtained from the vehicle sensor 8. The drive state determination unit 2 determines whether or not the other vehicle emits the warning tone or light such as a flash of light to the subject vehicle based on the information obtained from the periphery detection apparatus 23. When the drive state determination unit 2 determines that the other vehicle emits the warning tone or light such as a flash of light, the drive state determination unit 2 determines that the driver of the subject vehicle performs the reckless driving or the irritating driving on the other vehicle.

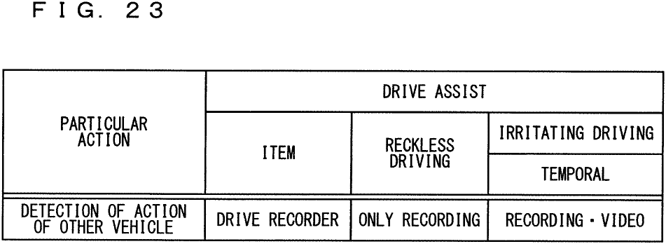

Example of the particular actions which the drive state determination unit 2 refers to in determining the reckless driving and the irritating driving based on the information obtained from the periphery detection apparatus 23 include “detection of an action of the other vehicle” illustrated in FIG. 23. The particular action illustrated in FIG. 23 is an exemplification, thus the other driving may be a particular action.

“Detection of an action of the other vehicle” illustrated in FIG. 23 indicates that detected is emission of the warning tone emitted from the other vehicle located around the subject vehicle to the subject vehicle or detected is emission of light such as a flash with light to the subject vehicle. In this case, the drive state determination unit 2 determines a usage state of the warning tone or lighting emitted from the other vehicle to the subject vehicle obtained from the periphery detection apparatus 23. Then, the drive state determination unit 2 determines which the driver of the subject vehicle performs, the reckless driving or the irritating driving, based on how the warning tone or lighting is used by the other vehicle for the subject vehicle. Specifically, the drive state determination unit 2 determines that the driver of the subject vehicle performs the reckless driving when the other vehicle located around the subject vehicle repeatedly executes the emission of the warning tone or light such as a flash with light to the subject vehicle more than a predetermined number of times. When the other vehicle located around the subject vehicle temporarily executes the emission of the warning tone or light such as a flash with light to the subject vehicle, the drive state determination unit 2 determines that the driver of the subject vehicle performs the irritating driving.

The assist controller 3 controls the video recording controller 12 so that the video recording controller 12 performs drive assist in accordance with each of the reckless driving or the irritating driving.

For example, when the drive state determination unit 2 determines that the driver of the subject vehicle performs the reckless driving based on the particular action illustrated in FIG. 23, the assist controller 3 transmits the instruction to the video recording controller 12 to record the video of the drive state of the subject vehicle before the subject vehicle is subject to the action from the other vehicle. The process is similar to that in the video recording controller 12 in FIG. 9.

For example, when the drive state determination unit 2 determines that the particular action illustrated in FIG. 23 is the irritating driving, the assist controller 3 transmits the instruction to the video recording controller 12 to record the video of the drive state of the subject vehicle before the subject vehicle is subject to the action from the other vehicle. The process is similar to that in the video recording controller 12 in FIG. 9. In this case, the driver is asked whether to confirm the video recorded in the drive recorder 13 or not when the subject vehicle is stopped.

### 4-2. Operation

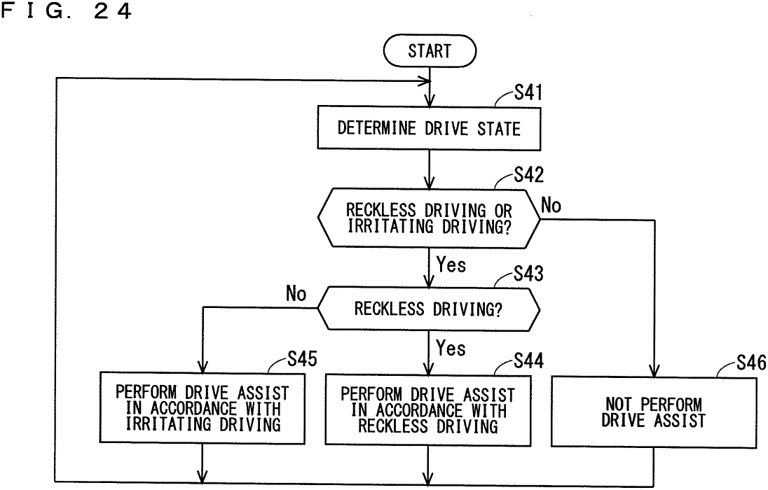

FIG. 24 is a flow chart illustrating an example of an operation of the drive assist apparatus 22.

In Step S41, the drive state determination unit 2 determines the drive state including the reckless driving and the irritating driving based on the information obtained from the vehicle sensor 8 and the periphery detection apparatus 23. The drive state determined herein is the drive state of the subject vehicle.

In Step S42, the drive state determination unit 2 determines whether or not the drive state of the subject vehicle is the reckless driving or the irritating driving. When the drive state is the reckless driving or the irritating driving, the process proceeds to Step S43. In the meanwhile, when the drive state is not the reckless driving or the irritating driving, the process proceeds to Step S46.

In Step S43, the drive state determination unit 2 determines whether or not the drive state is the reckless driving. When the drive state is the reckless driving, the process proceeds to Step S44. In the meanwhile, when the drive state is not the reckless driving, the process proceeds to Step S45.

In Step S44, the assist controller 3 performs drive assist in accordance with the reckless driving. For example, when the drive state determination unit 2 determines that the subject vehicle performs the reckless driving in accordance with the particular action illustrated in FIG. 23, the assist controller 3 transmits the instruction to the video recording controller 12 to record the video of the drive state of the subject vehicle before the subject vehicle is subject to the action from the other vehicle. The video recording controller 12 records the video of the drive state of the subject vehicle before the subject vehicle is subject to the action from the other vehicle. Accordingly, the video recorder 13 records the video of the drive state of the subject vehicle before the subject vehicle is subject to the action from the other vehicle.

In Step S45, the assist controller 3 performs drive assist in accordance with the irritating driving. For example, when the drive state determination unit 2 determines that the subject vehicle performs the irritating driving in accordance with the particular action illustrated in FIG. 23, the assist controller 3 transmits the instruction to the video recording controller 12 to record the video of the drive state of the subject vehicle before the subject vehicle is subject to the action from the other vehicle. The video recording controller 12 records the video of the drive state of the subject vehicle before the subject vehicle is subject to the action from the other vehicle. Accordingly, the video recorder 13 records the video of the drive state of the subject vehicle before the subject vehicle is subject to the action from the other vehicle. The driver is asked whether to confirm the video recorded in the drive recorder 13 or not when the subject vehicle is stopped.

In Step S46, the assist controller 3 does not perform drive assist. That is to say, the assist controller 3 does not transmit the instruction to the video recording controller 12.

### 4-3. Effect

As described above, according to the embodiment 4, the drive state determination unit 2 determines whether or not the subject vehicle performs the reckless driving or the irritating driving based on the information obtained from the periphery detection apparatus 23. The assist controller 3 controls the output controller 5 so that the output controller 5 performs drive assist in accordance with each of the reckless driving or the irritating driving. Accordingly, appropriate drive assist can be performed on the driver which has performed the reckless driving or the irritating driving.

### Embodiment 5

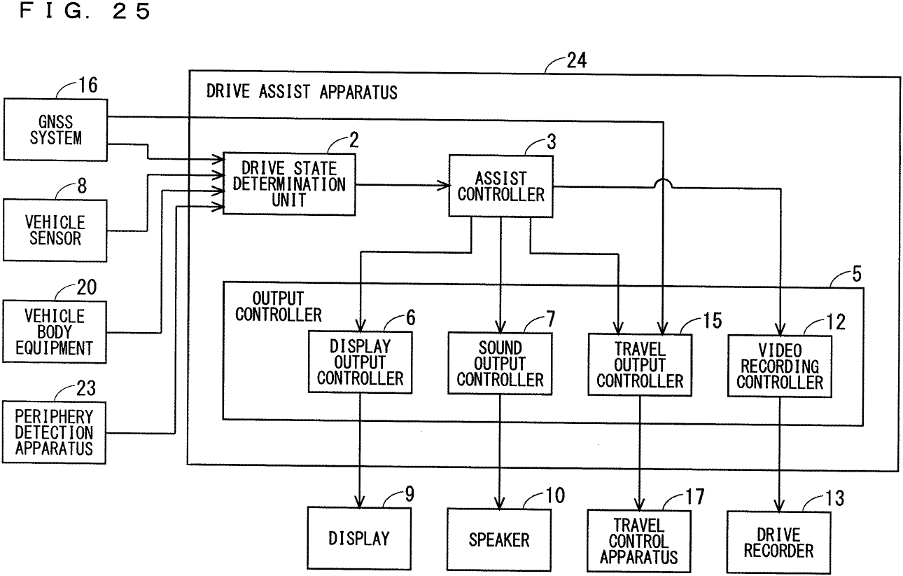

FIG. 25 is a block diagram illustrating an example of a configuration of a drive assist apparatus 24 according to an embodiment 5. Each constituent element and each operation of the drive assist apparatus 24 are the configurations and operations in which the drive assist apparatuses described in each of the embodiments 1 to 4 are combined, thus the description thereof is omitted herein.

As described above, the effects described in each of the embodiments 1 to 4 can be obtained according to the embodiment 5.

### Hardware Configuration

Each function of the drive state determination unit 2, the assist controller 3, the display output controller 6, and the sound output controller 7 in the drive assist apparatus 4 described in the embodiment 1 is achieved by a processing circuit. That is to say, the drive assist apparatus 4 includes a processing circuit for determining the drive state of the driver of the subject vehicle, controlling drive assist in accordance with the reckless driving or the irritating driving, performing control of displaying the assist information, and performing control of outputting the sound of the assist information. The processing circuit may be dedicated hardware or a processor (also referred to as a CPU, a central processor, a processing device, an arithmetic device, a microprocessor, a microcomputer, or a digital signal processor (DSP)) executing a program stored in a memory.

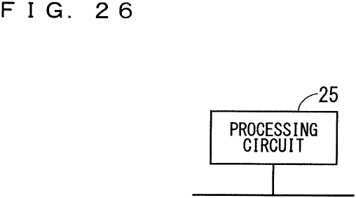

When the processing circuit is the dedicated hardware, a single circuit, a complex circuit, a programmed processor, a parallel-programmed processor, an application specific integrated circuit (ASIC), a field-programmable gate array (FPGA), or a combination of them, for example, falls under a processing circuit 25 as illustrated in FIG. 26. Each function of the drive state determination unit 2, the assist controller 3, the display output controller 6, and the sound output controller 7 may be achieved by the processing circuit 25 or each function may be collected to be achieved by one processing circuit 25.

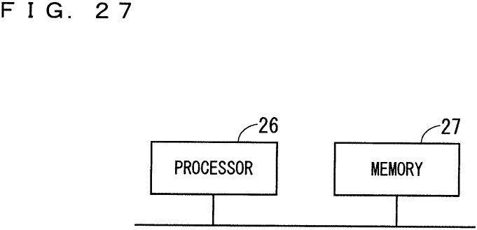

When the processing circuit 25 is a processor 26 illustrated in FIG. 27, each function of the drive state determination unit 2, the assist controller 3, the display output controller 6, and the sound output controller 7 is achieved by software, firmware, or a combination of software and firmware. The software or the firmware is described as a program and is stored in a memory 27. The processor 26 reads out and executes a program stored in the memory 27, thereby achieving each function. That is to say, the drive assist apparatus 4 includes the memory 27 for storing a program resultingly executing the step of determining the drive state of the driver of the subject vehicle, the step of controlling drive assist in accordance with the reckless driving or the irritating driving, the step of performing control of displaying the assist information, and the step of performing control of outputting the sound of the assist information. These programs are also deemed to make a computer execute procedures or methods of the drive state determination unit 2, the assist controller 3, the display output controller 6, and the sound output controller 7. Herein, a memory may be a non-volatile or volatile semiconductor memory such as a random access memory (RAM), a read only memory (ROM), a flash memory, an erasable programmable read only memory (EPROM), and an electrically erasable programmable read only memory (EEPROM), or, a magnetic disc, a flexible disc, an optical disc, a compact disc, a digital versatile disc (DVD), or any storage medium which is to be used in the future.

It is also applicable that some of each function of the drive state determination unit 2, the assist controller 3, the display output controller 6, and the sound output controller 7 is achieved by dedicated hardware and the other function thereof is achieved by software or firmware,

As described above, the processing circuit can achieve each function described above by the hardware, the software, the firmware, or the combination of them.

The hardware configuration of the drive assist apparatus 4 described in the embodiment 1 is described above, and the same applies to the configurations of the drive assist apparatus 11, the drive assist apparatus 14, the drive assist apparatus 18, the drive assist apparatus 19, the drive assist apparatus 21, and the drive assist apparatus 24 described in each of the embodiments 1 to 5.

### System Configuration

The drive assist apparatus described above can be applied not only to an in-vehicle navigation apparatus, that is to say, a car navigation apparatus but also a navigation apparatus constituted as a system by appropriately combining a portable navigation device (PND) which can be mounted on a vehicle and a server provided outside the vehicle or an apparatus other than the navigation apparatus built as the system. In this case, each function or each constituent element of the drive assist apparatus is separately disposed in each function constituting the system described above.

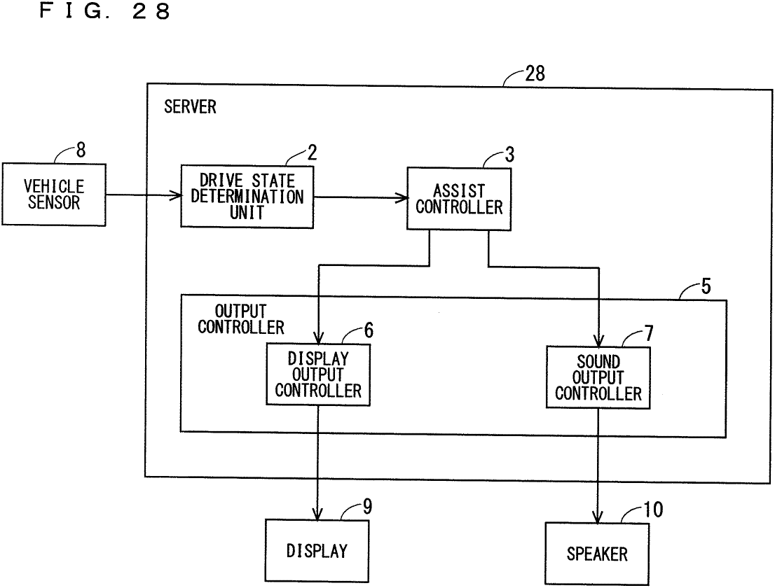

Specifically, the function of the drive assist apparatus can be disposed in a server as an example. For example, as illustrated in FIG. 28, the vehicle includes the vehicle sensor 8, the display 9, and the speaker 10. The server 28 includes the drive state determination unit 2, the assist controller 3, the display output controller 6, and the sound output controller 7. A drive assist system can be constituted by such a configuration.

Software executing the operations in the embodiments described above may be incorporated into the server, for example. A drive assist method achieved by the server executing this software includes: determining a drive state including reckless driving intentionally performed by a driver of a subject vehicle on the other vehicle and irritating driving accidentally performed by a driver of the subject vehicle but irritating a driver of the other vehicle; and performing control of assisting driving of the driver of the subject vehicle in accordance with a case of determining that the reckless driving is performed and a case of determining that the irritating driving is performed.

In this manner, the software executing the operations in the embodiments described above is incorporated into the server and operated, thus the effects similar to those in the embodiments described above can be obtained.

Described above is the case where each function of the drive assist apparatus 4 described in the embodiment 1 is applied to the server, and the same applies to the case of applying each function of the drive assist apparatus 11, the drive assist apparatus 14, the drive assist apparatus 18, the drive assist apparatus 19, the drive assist apparatus 21, and the drive assist apparatus 24 described in each of the embodiments 1 to 5 to the server.

Each embodiment can be arbitrarily combined, or each embodiment can be appropriately varied or omitted within the scope of the invention.

Although the present disclosure is described in detail, the foregoing description is in all aspects illustrative and does not restrict the disclosure. It is therefore understood that numerous modification examples can be devised.

### EXPLANATION OF REFERENCE SIGNS

1 drive assist apparatus, 2 drive state determination unit, 3 assist controller, 4 drive assist apparatus, 5 output controller, 6 display output controller, 7 sound output controller, 8 vehicle sensor, 9 display, 10 speaker, 11 drive assist apparatus, 12 video recording controller, 13 drive recorder, 14 drive assist apparatus, 15 travel output controller, 16 GNSS system, 17 travel control apparatus, 18 drive assist apparatus, 19 drive assist apparatus, 20 vehicle body equipment, 21 drive assist apparatus, 22 drive assist apparatus, 23 periphery detection apparatus, 24 drive assist apparatus, 25 processing circuit, 26 processor, 27 memory, 28 server.

1. A drive assist apparatus, comprising:
a processor to execute a program, and
a memory to store the program which, when executed by the processor, performs processes of:
determining a drive state including reckless driving intentionally performed by a driver of a subject vehicle on a particular another vehicle and irritating driving accidentally performed by a driver of a subject vehicle but irritating a driver of another vehicle based on a temporal sequence of a relative position of the subject vehicle and the another vehicle; and
performing control of assisting driving of the driver of the subject vehicle in accordance with each of a case where it is determined that that the reckless driving is performed and a case where it is determined that that the irritating driving is performed.

2. The drive assist apparatus according to claim 1, wherein
the determination of the drive state includes determination that a driver of the subject vehicle performs the reckless driving when the subject vehicle executes a particular action more than a predetermined number of times on the same another vehicle and determination that the driver of the subject vehicle performs the irritating driving when the subject vehicle temporarily or continuously executes the particular action on the same another vehicle.

3. The drive assist apparatus according to claim 1, wherein
the irritating driving includes temporal irritating driving and continuous irritating driving, and
the control of assisting the driving includes control of assisting driving of the driver of the subject vehicle in accordance with each of the temporal irritating driving and the continuous irritating driving.

4. The drive assist apparatus according to claim 2, wherein
the particular action includes a traveling interfering with a traveling of the another vehicle which intends to overtake the subject vehicle.

5. The drive assist apparatus according to claim 4, wherein
the traveling interfering with the traveling of the another vehicle includes a traveling in which the subject vehicle and the another vehicle are located on a fast lane and the subject vehicle is located in front of the another vehicle.

6. The drive assist apparatus according to claim 4, wherein
the traveling interfering with the traveling of the another vehicle includes a traveling in which the subject vehicle and the another vehicle are located on a no-passing road and the subject vehicle is located in front of the another vehicle.

7. The drive assist apparatus according to claim 2, wherein
the particular action includes a traveling in which the subject vehicle gets close to the another vehicle within a predetermined distance and a traveling of the subject vehicle making the another vehicle perform an avoidance action.

8. The drive assist apparatus according to claim 7, wherein
the traveling in which the subject vehicle gets close to the another vehicle and the traveling of making the another vehicle perform the avoidance action include a traveling of the subject vehicle pulling over to the another vehicle traveling along an adjacent traffic lane, a traveling of suddenly entering in front of the another vehicle to cut into a lane of the another vehicle, a traveling of the subject vehicle braking suddenly in front of the another vehicle, and an unsteady traveling of the subject vehicle around the another vehicle.

9. The drive assist apparatus according to claim 2, wherein
the particular action includes an action of the subject vehicle using a vehicle body equipment for the another vehicle.

10. The drive assist apparatus according to claim 9, wherein
the action using the vehicle body equipment includes a heavy use of a warning tone for the another vehicle in front of the subject vehicle or and a heavy use of flashing of lighting for the another vehicle in front of the subject vehicle.

11. The drive assist apparatus according to claim 1, comprising:
performing control of displaying assist information of assisting driving for the driver in accordance with the control of assisting the driving; and
performing control of outputting the assist information with a sound to the driver in accordance with the control of assisting the driving, wherein
when it is determined that the reckless driving is performed, control of displaying the assist information is performed, and control of outputting the assist information with a sound is not performed, and
when it is determined that the irritating driving is performed, control of displaying the assist information is performed, and control of outputting the assist information with a sound is performed.

12. The drive assist apparatus according to claim 11, wherein
when the subject vehicle and the another vehicle are located on a no-passing road and the subject vehicle is located in front of the another vehicle, it is determined that the reckless driving or the irritating driving is performed, and
control of displaying an empty space located in a travel destination of the subject vehicle is performed.

13. The drive assist apparatus according to claim 1, comprising
performing automatic control of a traveling of the subject vehicle in accordance with the control of assisting the driving.

14. The drive assist apparatus according to claim 13, wherein
when the subject vehicle and the another vehicle are located on a fast lane and the subject vehicle is located in front of the another vehicle, it is determined that that the reckless driving or the irritating driving is performed, and
the automatic control is performed so that the subject vehicle changes a traffic lane to a driving lane.

15. The drive assist apparatus according to claim 13, wherein
when the subject vehicle and the another vehicle are located on a no-passing road and the subject vehicle is located in front of the another vehicle, it is determined that the reckless driving or the irritating driving is performed, and
the automatic control is performed so that the subject vehicle is moved to an empty space located in a travel destination of the subject vehicle.

16. The drive assist apparatus according to claim 1, comprising
performing control of recording a video of a drive state where it is determined that the reckless driving or the irritating driving is performed in accordance with the control of assisting the driving.

17. The drive assist apparatus according to claim 16, wherein
the control of recording the video includes control of recording the video in an external server.

18. The drive assist apparatus according to claim 16, comprising
performing control of displaying assist information of assisting driving for the driver in accordance with the control of assisting the driving, wherein
the control of displaying the assist information includes control of displaying the video recorded by the control of recording the video.

19. The drive assist apparatus according to claim 16, wherein the determination of the drive state includes determination whether or not the subject vehicle performs the irritating driving based on an action of the another vehicle for the subject vehicle, and
when it is determined that the subject vehicle performs the irritating driving, control of recording a drive state of the subject vehicle before the action of the another vehicle is performed.

20. A drive assist method, comprising:
determining a drive state including reckless driving intentionally performed by a driver of a subject vehicle on a particular another vehicle and irritating driving accidentally performed by a driver of a subject vehicle but irritating a driver of another vehicle based on a temporal sequence of a relative position of the subject vehicle and the another vehicle; and
performing control of assisting driving of the driver of the subject vehicle in accordance with each of a case where the reckless driving is performed and a case where the irritating driving is performed.
